(19) United States
(12) Patent Application Publication
(10) Pub. No.: US 2026/0094978 A1
(43) Pub. Date: Apr. 2, 2026

(54) BASE STATION ANTENNA

(71) Applicant: Outdoor Wireless Networks LLC, Richardson, TX (US)

(72) Inventors: Guiyu Sun, Suzhou (CN); Fangwen Wan, Suzhou (CN)

(21) Appl. No.: 19/332,379

(22) Filed: Sep. 18, 2025

(30) Foreign Application Priority Data
Sep. 29, 2024 (CN) 2024113789298

(51) Int. Cl. H01Q 21/26; H01Q 1/24; H01Q 15/14; H01Q 21/30

(52) U.S. Cl. CPC H01Q 21/26; H01Q 1/246; H01Q 15/14; H01Q 21/30

(57) ABSTRACT

A base station antenna comprises a reflector, a radiator positioned in front of the reflector and configured to operate within a first operating frequency range; and a phase gradient meta-surface (PGM) positioned between the radiator and the reflector. The PGM comprises a dielectric substrate having a conductive cell array disposed thereon. The PGM is configured to apply a phase gradient to radiation incident on the PGM within the first operating frequency range.

### CROSS-REFERENCE TO RELATED APPLICATION

The present application claims priority to Chinese Patent Application No. 2024113789298, filed Sep. 29, 2024, the entire content of which is incorporated herein by reference as if set forth fully herein.

### FIELD

The present disclosure generally relates to the field of antennas, and more specifically, the present disclosure relates to base station antennas.

### BACKGROUND

In a typical cellular communication system, a geographic area is divided into a series of regions that are referred to as “cells”, and each cell is served by one or more base stations. Each base station may comprise baseband units, radio devices, and antennas, where the antennas may be configured to provide two-way radio frequency (RF) communications with stationary and mobile subscribers (which may be referred to as users) geographically positioned within the cell. In many cases, a cell may be divided into a plurality of sectors, and each individual antenna provides coverage to a respective sector. Antennas are usually installed on a tower or other raised structures and outwardly directed radiation beams (“antenna beams”) generated by each antenna provide service to serve the corresponding sectors.

The azimuth beamwidth (AZBW) refers to the width of a radiation pattern generated by an antenna in the azimuth plane and is typically used to describe the radiation capability of the antenna in the horizontal direction. The AZBW is typically characterized as a beamwidth (in degrees) for which the radiation pattern has a certain power level as compared to a peak power level. For example, the 3 dB AZBW refers to the width (in degrees) of the radiation pattern in a cut taken through the azimuth plane at the elevation angle where the radiation pattern has peak power level where the main lobe of the radiation pattern is within 3 dB of the peak power level. The smaller the AZBW is, the greater the antenna is capable of concentrating energy in a particular direction. In particular, a smaller AZBW can make the antenna more directional as the signals are more focused in a particular direction to improve the intensity and quality of the signals. In environments where there are multiple signal sources or noises, the smaller AZBW can effectively reduce unnecessary signals or interference from other directions, helping to improve clarity and transmission reliability of the signals.

### SUMMARY

According to one aspect of the present disclosure, a base station antenna is provided, wherein the base station antenna comprises: a reflector; a first radiator positioned in front of the reflector and configured to operate within a first operating frequency range; and a dielectric substrate positioned between the first radiator and the reflector and having a conductive cell array disposed thereon. The dielectric substrate having the conductive cell array constitutes a phase gradient meta-surface (PGM), wherein the PGM is configured to apply a phase gradient to radiation incident on the PGM within the first operating frequency range.

In some examples, the PGM and the reflector are configured to cooperate together to reflect at least 97% of radiation emitted rearwardly by the first radiator.

In some examples, the PGM is configured to reflect a first part of the rearwardly emitted radiation of the first radiator, the reflector is configured to reflect a second part of the rearwardly emitted radiation of the first radiator, and the second part transmits through the PGM.

In some examples, each conductive cell in the conductive cell array comprises a conductive trace having a substantially circular outer profile. In some examples, an inner radius of the conductive trace is approximately one tenth of a wavelength at a central operating frequency of the first operating frequency range. In some examples, each conductive cell comprises a substantially square conductive patch disposed within a perimeter defined by a conductive trace segment. In some examples, the inner radius of the conductive trace is approximately one tenth of the wavelength at the central operating frequency of the first operating frequency range, and a length of a side of the conductive patch is approximately the same length an outer radius of the conductive trace.

In some examples, the base station antenna comprises a second radiator positioned in front of the reflector and closer to the reflector than the conductive cell array, the second radiator is configured to operate within a second operating frequency range, and the second operating frequency range is higher than the first operating frequency range. The PGM is configured to allow radiation within the second operating frequency range to pass through the PGM. In some examples, a choker is disposed in the conductive trace. For example, a length of the choker is approximately a quarter of a wavelength at a central operating frequency of the second operating frequency range.

In some examples, the first radiator comprises a first dipole arranged along a first axis, and the conductive cell array comprises first plurality of conductive cells arranged along the first axis. In some examples, sizes of the first plurality of conductive cells gradually increase in a direction parallel to the first axis. In some examples, the first plurality of conductive cells are identical in size to each other.

In some examples, the first radiator comprises a second dipole arranged along a second axis that is substantially perpendicular to the first axis. In some examples, the conductive cell array comprises second plurality of conductive cells arranged along the second axis. In some examples, the conductive cell array does not comprise conductive cells arranged along the second axis.

In some examples, the base station antenna comprises a plurality of first radiators arranged in a single column, each of the plurality of first radiators comprises a first dipole arranged along a first axis and a second dipole arranged along a second axis that is substantially perpendicular to the first axis, a respective conductive cell array is disposed between each of the plurality of first radiators and the reflector, and the conductive cell array comprises first plurality of conductive cells arranged along the first axis and second plurality of conductive cells arranged along the second axis.

In some examples, the base station antenna comprises a plurality of first radiators arranged in two columns, each of the plurality of first radiators comprises a first dipole arranged along a first axis and a second dipole arranged along a second axis substantially perpendicular to the first axis, a respective conductive cell array is disposed between each of the plurality of first radiators and the reflector, and the conductive cell array comprises first plurality of conductive cells arranged along the first axis and does not comprise conductive cells arranged along the second axis.

In some examples, the first radiator is positioned on a forward end of a first feed stalk that extends forwardly of the reflector, and the conductive cell array comprises a first sub-array positioned on a first side of the first feed stalk and a second sub-array positioned on a second side of the first feed stalk that is opposite to the first side. In some examples, the dielectric substrate comprises a first dielectric substrate and a second dielectric substrate, the first sub-array is disposed on the first dielectric substrate, the second sub-array is disposed on the second dielectric substrate, and the first feed stalk extends through a gap between the first dielectric substrate and the second dielectric substrate. In some examples, the dielectric substrate comprises an opening positioned between the first sub-array and the second sub-array, and the first feed stalk extends through the opening. In some examples, the conductive cell array comprises a conductive cell positioned at the first feed stalk, the dielectric substrate comprises an opening positioned in the conductive cell, and the first feed stalk extends through the opening.

In some examples, the first radiator is approximately a quarter of the wavelength at the central operating frequency of the first operating frequency range from the reflector, and the conductive cell array is approximately one eighth of the wavelength at the central operating frequency of the first operating frequency range from the reflector.

According to another aspect of the present disclosure, a base station antenna is provided, wherein the base station antenna comprises: a reflector; a radiator positioned in front of the reflector; and a dielectric substrate positioned between the radiator and the reflector and having a conductive cell array disposed thereon. Each conductive cell in the conductive cell array comprises a conductive trace having a substantially circular outer profile.

In some examples, an inner radius of the conductive trace is approximately one tenth of a wavelength at a central operating frequency of an operating frequency range of the radiator.

In some examples, each conductive cell comprises a substantially square conductive patch disposed within a perimeter defined by a conductive trace segment. In some examples, the inner radius of the conductive trace is approximately one tenth of the wavelength at the central operating frequency of the operating frequency range of the radiator, and a length of a side of the conductive patch is approximately the same length an outer radius of the conductive trace.

In some examples, a choker is disposed in the conductive trace. In some examples, a length of the choker is approximately a quarter of a wavelength at a central operating frequency of another operating frequency range that is higher than the operating frequency range of the radiator.

In some examples, the radiator comprises a first dipole arranged along a first axis, and the conductive cell array comprises first plurality of conductive cells arranged along the first axis. In some examples, sizes of the first plurality of conductive cells gradually increase in a direction parallel to the first axis. In some examples, the first plurality of conductive cells are identical in size to each other.

In some examples, the radiator comprises a second dipole arranged along a second axis that is substantially perpendicular to the first axis. In some examples, the conductive cell array comprises second plurality of conductive cells arranged along the second axis. In some examples, the conductive cell array does not comprise conductive cells arranged along the second axis.

In some examples, the base station antenna comprises a plurality of radiators arranged in a single column, each of the plurality of first radiators comprises a first dipole arranged along a first axis and a second dipole arranged along a second axis that is substantially perpendicular to the first axis, a respective conductive cell array is disposed between each of the plurality of first radiators and the reflector, and the conductive cell array comprises first plurality of conductive cells arranged along the first axis and second plurality of conductive cells arranged along the second axis.

In some examples, the base station antenna comprises a plurality of radiators arranged in two columns, each of the plurality of first radiators comprises a first dipole arranged along a first axis and a second dipole arranged along a second axis that is substantially perpendicular to the first axis, a respective conductive cell array is disposed between each of the plurality of first radiators and the reflector, and the conductive cell array comprises first plurality of conductive cells arranged along the first axis and does not comprise conductive cells arranged along the second axis.

In some examples, the radiator is positioned on a forward end of a feed stalk that extends forwardly from the reflector, and the conductive cell array comprises a first sub-array positioned on a first side of the feed stalk and a second sub-array positioned on a second side of the feed stalk that is opposite to the first side. In some examples, the dielectric substrate comprises a first dielectric substrate and a second dielectric substrate, the first sub-array is disposed on the first dielectric substrate, the second sub-array is disposed on the second dielectric substrate, and the feed stalk extends through a gap between the first dielectric substrate and the second dielectric substrate. In some examples, the dielectric substrate comprises an opening positioned between the first sub-array and the second sub-array, and the feed stalk extends through the opening. In some examples, the conductive cell array comprises a conductive cell positioned at the feed stalk, the dielectric substrate comprises an opening positioned in the conductive cell, and the feed stalk extends through the opening.

In some examples, the radiator is approximately a quarter of the wavelength at the central operating frequency of the operating frequency range of the radiator from the reflector, and the conductive cell array is approximately one eighth of the wavelength at the central operating frequency of the operating frequency range of the radiator from the reflector.

### BRIEF DESCRIPTION OF THE DRAWING

FIG. 1 schematically depicts an upward view of a base station antenna according to some examples of the present disclosure.

FIG. 2 schematically depicts an example of a conductive cell employed by a phase gradient meta-surface in a base station antenna according to some examples of the present disclosure.

FIG. 3 schematically depicts an upward view of a base station antenna according to some examples of the present disclosure.

FIG. 4 schematically depicts an example of a conductive cell employed by a phase gradient meta-surface in a base station antenna according to some examples of the present disclosure.

FIGS. 5-8 schematically depict front views of base station antennas according to some examples of the present disclosure.

FIGS. 9 and 10 schematically depict front views of base station antennas according to some examples of the present disclosure, respectively.

FIG. 11 shows changes in amplitudes and phases of radiation reflected by the phase gradient meta-surface and radiation transmitted by the phase gradient meta-surface as a function of frequency in a base station antenna according to a first exemplary example of the present disclosure, respectively.

FIG. 12 schematically depicts a front view of a base station antenna according to a first comparative example and a base station antenna according to a second exemplary example of the present disclosure.

FIG. 13 shows radiation patterns of the two base station antennas in FIG. 12 during operation.

FIG. 14 shows peak directionality and peak realization gains of the two base station antennas in FIG. 12 during operation.

FIG. 15 schematically depicts front views of a base station antenna according to a second comparative example and base station antennas according to third to fifth exemplary examples of the present disclosure.

FIG. 16 schematically depicts perspective views and front views of the base station antenna according to a third comparative example and base station antennas according to sixth to seventh exemplary examples of the present disclosure.

FIG. 17 shows radiation patterns of the three base station antennas in FIG. 16 when dipoles of two adjacent mid-frequency band radiating elements that incline at +45° are activated.

FIG. 18 shows peak directionality and peak realization gains of the three base station antennas in FIG. 16 when dipoles of two adjacent mid-frequency band radiating elements that incline at +45° are activated.

FIG. 19 shows radiation patterns of two base station antennas in FIG. 16 when dipoles of low-frequency band radiating elements that incline at +45° are activated.

FIG. 20A shows three-dimensional directionality and realized gains of the two base station antennas in FIG. 16 when the dipoles of the low-frequency band radiating elements that incline at +45° are activated, and FIG. 20B shows the 3 dB AZBW and 10 dB AZBW of the two base station antennas in FIG. 16 when the dipoles of the low-frequency band radiating elements that incline at +45° are activated.

FIG. 21 shows radiation patterns of the two base station antennas in FIG. 16 when the dipoles of the low-frequency band radiating elements that incline at −45° are activated.

FIG. 22 shows three-dimensional directionality, realization gains, and 3 dB AZBW of the two base station antennas in FIG. 16 when the dipoles of the low-frequency band radiating elements that incline at −45° are activated.

It should be noted that in the examples described below, the same reference signs are sometimes used across different attached drawings to denote the same parts or parts with similar functions, and repeated descriptions thereof are omitted. In some cases, similar mark numbers and letters are used to denote similar items. Therefore, once a certain item is defined in one attached drawing, there is no need for further discussion in subsequent attached drawings.

For case of understanding, the position, dimension, and range of each structure shown in the attached drawings and the like sometimes do not represent the actual position, dimension, and range. Therefore, the present disclosure is not limited to the positions, dimensions, and ranges disclosed in the attached drawings and the like.

### DETAILED DESCRIPTION

Various exemplary examples of the present disclosure will be described in detail below by referencing the attached drawings. It should be noted that: unless otherwise specifically stated, the relative arrangement, numerical expressions and numerical values of components and steps set forth in these examples do not limit the scope of the present disclosure.

The following description of at least one exemplary example is actually only illustrative, and in no way serves as any limitation to the present disclosure and its application or use. In other words, the structure and method herein are shown in an exemplary manner to illustrate different examples of the structure and method in the present disclosure. However, those skilled in the art will understand that they only illustrate exemplary ways of implementing the present disclosure, rather than exhaustive ways. In addition, the attached drawings are not necessarily drawn to scale, and some features may be enlarged to show details of specific components.

In addition, the technologies, methods, and equipment known to those skilled in the art may not be discussed in detail, but where appropriate, the technologies, methods, and equipment should be regarded as part of the Specification.

In all examples shown and discussed herein, any specific value should be construed as merely exemplary value and not as limiting value. Therefore, other examples of the exemplary example may have different values.

Typically, in cellular base station antenna applications, the low-frequency band (LB) may be a frequency range of 617 MHz-960 MHz or a part thereof, and the mid-frequency band (MB) may be a frequency range of 1.7 GHZ-2.7 GHZ or a part thereof. In some instances, higher frequency bands may also be involved, for example, such as, for example, a high-frequency band (HB) that may encompass a frequency range of 3.3 GHZ-4.2 GHz or a part thereof.

The smaller the AZBW (e.g., 3 dB AZBW, 10 dB AZBW, etc.) that an antenna exhibits, the better its orientation ability and anti-jamming capability. In general, the AZBW of the low-frequency band radiating element will be wider than the AZBW of the mid-frequency band radiating element, which may be caused by the following aspects. In terms of the radiation wavelength, low-frequency band radiating elements have longer radiation wavelengths than mid-frequency band radiating elements, causing a weaker radiation directionality, thereby resulting in a wider radiation angle range. In terms of the antenna design, the low-frequency band radiating elements have a larger structure than the mid-frequency band radiating elements, which enables it to be capable of more evenly radiating energy, thereby forming wider radiation patterns. In terms of phase matching, in the low-frequency bands, the interference effect of adjacent radiating elements is reduced due to the relatively slow phase changes of electromagnetic waves, resulting in broader radiation directions; while in the mid-frequency bands, the phase changes of electromagnetic waves are rapid, resulting in greater directionality. Therefore, it is desirable to reduce the AZBW of arrays of radiating elements in a base station antenna, particularly the AZBW of the low-frequency band array(s).

Increasing a width of a reflector of the antenna is one way to reduce the AZBW, but this obviously increases the volume of the antenna, making it heavier and more difficult to install, resulting in a significant increase in costs. Two known techniques for reducing the AZBW are to stagger the radiating elements of an array in the horizontal direction and using couplers to share at least some radiating elements of two side-by-side arrays in order to increase the aperture of the array in the azimuth plane. While both techniques are effective in reducing the AZBW, the staggered array design may reduce three-dimensional (3D) directionality and gains, and the coupler approach may increase insertion losses and decrease gains. Moreover, the coupler approach is not suitable for antennas with a single-column low-frequency band radiating elements.

The present disclosure provides a base station antenna that includes phase gradient meta-surface (PGM) that can be used to accelerate phase changes in the radiation patterns for purposes of narrowing the AZBW. A PGM is an artificial material having special structures and functions, and is capable of manipulating phases, amplitudes, and polarization characteristics of electromagnetic waves. The PGM typically consists of a plurality of microcells (referred to as “meta-surface cells” or “PGM cells”). By designing the arrangement and shape of these cells, phase modulation of incident electromagnetic waves may be achieved. The PGM is also capable of efficiently reflecting or transmitting electromagnetic waves at a particular frequency while remaining transparent to electromagnetic waves at other frequencies. By providing PGMs in the base station antennas of the present disclosure, a phase gradient can be applied to antenna beams that accelerates phase changes of the antenna beams in order to reduce AZBW of the generated antenna beams.

The base station antennas according to various examples of the present disclosure will be elaborated below with reference to the attached drawings. It should be understood that the actual base station antenna may further comprise other components, but to avoid obscuring the key elements of the present disclosure, they will not be discussed herein, and these other components will also not be shown in the attached drawings. For case of illustration, in various attached drawings, the Z direction is the direction in which an antenna is installed (typically the direction perpendicular to the ground plane), the Y direction is the direction transverse to an antenna back plate, which collectively defines, together with the Z direction, a plane in which the antenna back plate is positioned, and the X direction is the direction perpendicular to the antenna back plate. It will be understood that since antennas are typically vertically installed, the description herein that one element is positioned in front of another element is performed in the case that the antenna is seen from the front.

It will be appreciated that the base station antennas are shown in the drawings with the radiating elements extending upwardly from a reflector of the antenna. In use, the base station antennas are rotated 90° so that the radiating elements are positioned in front of the reflector. The description below will describe the relative positioning of components of the base station antennas as if the base station antennas were mounted for use, even though the base station antennas are rotated 90° from this orientation in the drawings.

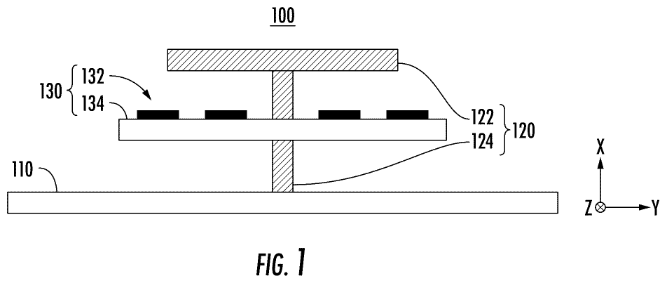

FIG. 1 is a schematic side view of a small portion of a base station antenna 100 according to some examples of the present disclosure with the radome and various other components of the antenna omitted. As shown in FIG. 1, the base station antenna 100 comprises a reflector 110 and a radiating element 120. The radiating element 120 generally comprises a feed stalk 124 and a radiator 122 positioned at the front end of the feed stalk 124. The feed stalk 124 is mounted to extend forwardly from the the reflector 110, such that the radiator 122 is positioned in front of the reflector 110. The radiator 122 is configured to operate within a first operating frequency range (e.g., a low-frequency band). The reflector 110 can be used to reflect rearward radiation of the radiator 122 back to the front.

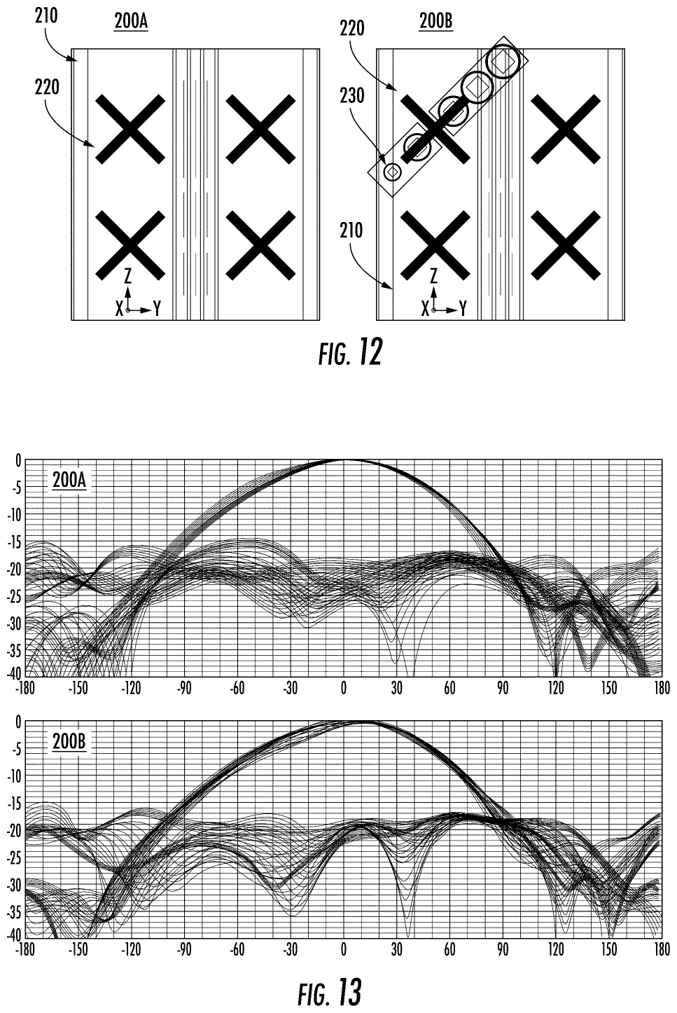

The base station antenna 100 also comprises a dielectric substrate 134 positioned between the radiator 122 and the reflector 110. The dielectric substrate 134 has a conductive cell array 132 disposed thereon. The dielectric substrate 134 having the conductive cell array 132 can constitute a PGM 130. The PGM 130 is capable of applying a phase gradient to radiation incident on the PGM 130. For example, such radiation may comprise radiation directly from the radiator 122 or may comprise radiation reflected by the reflector 110 onto the PGM. FIG. 11 exemplarily shows changes in magnitude and phase of radiation reflected by the PGM and radiation transmitted by the PGM with frequency, respectively. As can be seen from FIG. 11, the PGM 130 is capable of applying a phase gradient to antenna beams in a frequency space.

The PGM 130 is capable of providing substantially complete reflection for radiation that is emitted rearwardly by the radiator 122 in combination with the reflector 110. The “substantially complete reflection” as described herein may refer to greater than 95% of the rearwardly-directed radiation is reflected, e.g., at least 97% of the rearwardly-directed radiation is reflected, more preferably at least 99% of the rearwardly-directed radiation is reflected, most preferably 100% of the rearwardly-directed radiation is reflected. For example, the PGM may reflect a first part of the rearward radiation of the radiator 122, and the reflector 110 may reflect a second part of the rearward radiation of the radiator 122, and the second part transmits through the PGM 130.

When the radiator 122 is in operation, the PGM 130 can, in one aspect, perform phase control on the radiation incident thereon within the first operating frequency range, and can, in another aspect, enhance the reflection of the rearward radiation of the radiator 122 together with the reflector 110, thereby being capable of reducing the AZBW of the antenna beams emitted by the radiator 122.

In some examples, the radiator 122 is positioned approximately a quarter of the wavelength at the central operating frequency of the first operating frequency range forwardly from the reflector 110, and the conductive cell array 132 is positioned approximately one eighth of the wavelength at the central operating frequency of the first operating frequency range forwardly from the reflector 110. In some examples, the radiator 122 has an electrical length that is approximately a quarter of the wavelength at the central operating frequency of the first operating frequency range. In this context, “approximately” can mean equal to the value described or within +20% of the value described, preferably within +10%, more preferably within +5%, most preferably within +1%, etc.

The conductive cell array 132 and the dielectric substrate 134 may be prepared with any suitable materials. For example, they can be prepared using a printed circuit board (PCB) process. Examples of materials used to form the conductive cell array comprise, but are not limited to, high-conductivity materials such as copper, gold, silver, or combinations thereof.

In addition, conductive cells in the conductive cell array 132 may be designed according to the characteristics desired to be achieved by the PGM 130. It may be advantageous for the radiation patterns to provide the conductive cells with rotational symmetry. For example, each conductive cell in the conductive cell array 132 may comprise a conductive trace having a substantially circular outer profile. Such conductive trace can be closed, and thus can be operated as an inductor. Each conductive cell may also comprise a substantially square conductive patch disposed within a perimeter defined by a conductive trace segment. Such conductive patch may be spaced apart from the conductive trace, and a gap between the two may form a capacitor. By designing the specific shape, size, spacing, etc. of the conductive trace and/or conductive patch, an equivalent LC resonant circuit with a desired equivalent inductance value and equivalent capacitance value can be achieved. In some examples, an inner radius of the conductive trace is approximately one tenth of the wavelength at the central operating frequency of the first operating frequency range. In some examples, a length of a side of the conductive patch is approximately the same length as the outer radius of the conductive trace, that is, the sum of the inner radius of the conductive trace and the width of the conductive trace.

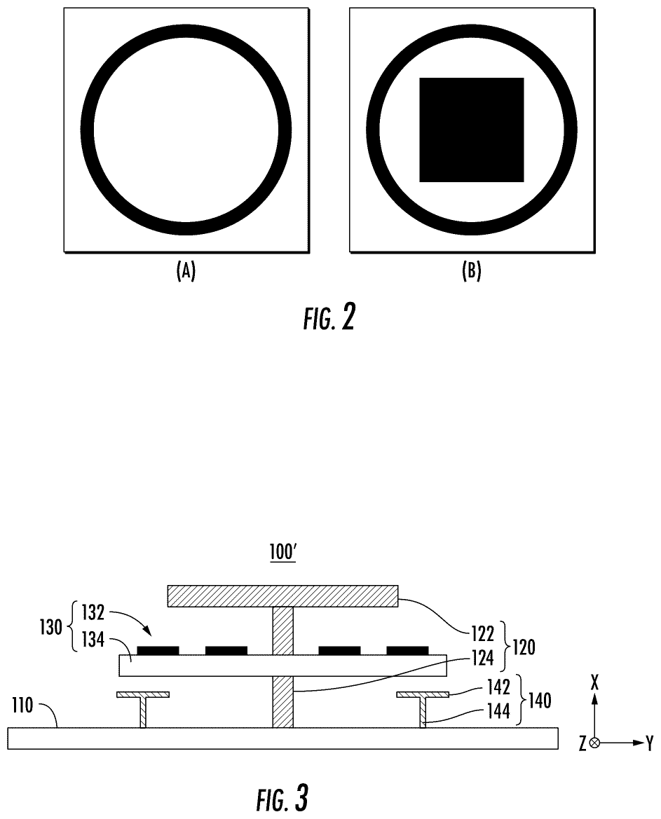

FIG. 2 shows two non-limiting examples of the conductive cell, wherein (A) depicts a conductive cell having an annular conductive trace, and (B) depicts a conductive cell having an annular conductive trace and a square conductive patch positioned at the center of the annular conductive trace. For example, when the first operating frequency range is a low-frequency band, for the central operating frequency 827 MHz, the annular conductive trace can have an inner radius of 32 mm and a width of 2 mm, and the square conductive patch may have a length of a side of 34 mm.

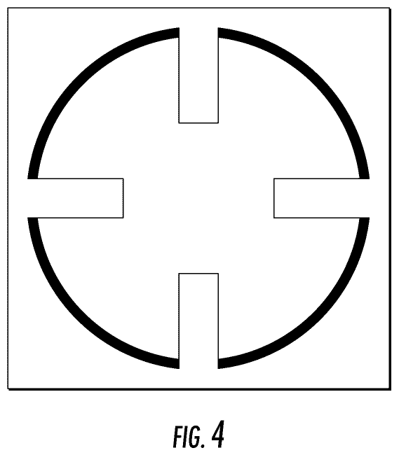

FIG. 3 shows a base station antenna 100′ according to some other examples of the present disclosure. Compared to the base station antenna 100, the base station antenna 100′ also comprises a pair of radiating elements 140. Each radiating element 140 comprises a feed stalk 144 and a radiator 142 positioned on the front end of the feed stalk 144. The feed stalk 144 is mounted to extend forwardly from the reflector 110, and thus the radiator 142 is positioned in front of the reflector 110. The radiator 142 is configured to operate within a second operating frequency range (e.g., a mid-frequency band) that is higher than the first operating frequency range. The reflector 110 can be used to reflect rearwardly directed radiation emitted by the radiator 142 back in the forward direction. In example embodiments, the radiating element 120 can be a low-frequency band radiating element, and the radiating element 140 can be a mid-frequency band radiating element.

As shown in FIG. 3, the radiator 142 is closer to the reflector 110 than the conductive cell array 132. In some instances, the radiator 142 may be positioned between the conductive cell array 132 and the reflector 110. That is, in the front view of the base station antenna 100′, the radiator 142 may be behind the PGM 130. Therefore, it is desirable for the PGM 130 to be “invisible” to radiation emitted by the radiator 142 so that the radiation emitted by radiator 142 is not blocked by the PGM 130. For example, the PGM 130 may be configured to allow the radiation within the second operating frequency range to pass therethrough. In some examples, a choke may be formed in the conductive trace of each conductive cell in the conductive cell array 132. The current induced by the radiation within the second operating frequency range in the conductive trace will be reversed on opposed sides of the choke, thereby cancelling in the far field radiation. Specifically, the choke may have a first portion in which the current induced by the radiation within the second operating frequency range flows along a first direction and a second portion in which the current induced by the radiation within the second operating frequency range flows along a second direction that is opposite to the first direction. In some examples, a length of the choke may be approximately a quarter of the wavelength at the central operating frequency of the second operating frequency range.

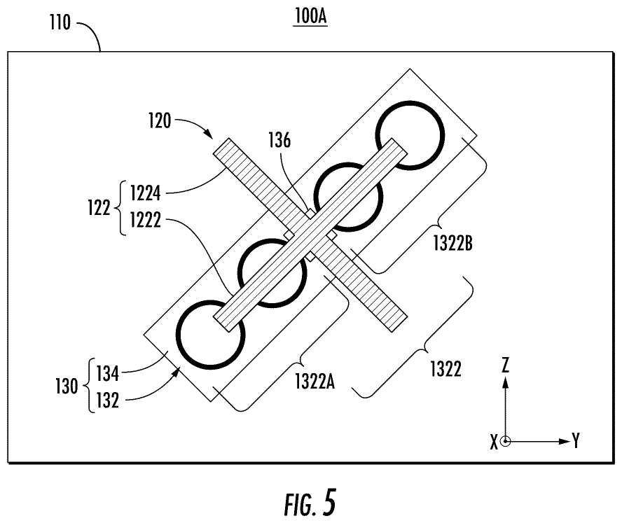

FIG. 4 shows a non-limiting example of a conductive cell having four chokes formed therein. As shown in FIG. 4, a plurality of arcuate conductive segments and a plurality of U-shaped conductive segments are alternatively connected to form a closed conductive trace having a substantially circular outer profile. These U-shaped conductive segments act as chokes, and their lengths may be approximately a quarter of the wavelength at the central operating frequency of the second operating frequency range. Various arcuate conductive segments may be identical in length to one another, and the inner radius of the conductive trace may be approximately one tenth of the wavelength at the central operating frequency of the first operating frequency range. For example, when the first operating frequency range is the low-frequency band and the second operating frequency band is the mid-frequency band, the inner radius of the conductive trace may be 32 mm, the lengths of two long edges of the U-shaped conductive segment may be 15.7 mm, and the lengths of a short edge of the U-shaped conductive segment may be 7 mm, so that the total length of the U-shaped conductive segment is 38.4 mm. Taking the bottommost U-shaped conductive segment as an example for illustration, currents flowing upward and flowing downward are induced by the radiation within the second operating frequency range in left and right portions of the U-shaped conductive segment, respectively, thereby cancelling in the far field radiation.

By virtue of the chokes, the PGM 130 has no, or less, impact on the operation of the radiator 142, and thus is free to consider the arrangement of the radiating element 140 and the arrangement of the PGM 130 separately without worrying that the overlapping layout of the two affects the operating performance of the radiating element 140, which facilitates high integration and miniaturization of the base station antenna while maintaining high performance. In some examples, the radiator 122 is approximately a quarter of the wavelength at the central operating frequency of the first operating frequency range from the reflector 110, the conductive cell array 132 is approximately one eighth of the wavelength at the central operating frequency of the first operating frequency range from the reflector 110, and the radiator 142 is approximately a quarter of the wavelength at the central operating frequency of the second operating frequency range from the reflector 110.

It will be understood that a respective PGM may also be disposed between the radiator 142 and the reflector 110 to optimize the AZBW of the radiator 142. Considering that the radiator 142 is typically operated in a mid-frequency band and thus has good AZBW, whether a PGM is provided may be determined according to actual needs.

In the attached drawings below, for purposes of illustration, the conductive cell is depicted primarily as (A) of FIG. 2, but this is merely exemplary and not limiting.

In some examples, the radiating element 120 may be a dipole radiating element, and the radiator 122 may be a dipole radiator. The radiating element may be a single polarization radiating element in which case it will have a single dipole radiator 122, or may be a dual-polarized radiating element, in which case it will have two dipole radiators 122. It will be understood that in other examples, the base station antenna may use different types of radiating elements. Thus, for example, in other examples, the radiating element 120 may be implemented as a patch radiating element, a slot radiating element, a horn radiating element, or any other suitable radiating element, and these radiating elements may be single polarization or dual-polarization radiating elements.

For a single polarization dipole radiator, the conductive cells in the conductive cell array 132 may be arranged along the single dipole thereof. For a dual-polarization dipole radiator, the conductive cells in the conductive cell array 132 may be arranged along one or both dipole radiators. In the attached drawings below, for purposes of illustration, the radiator 122 is depicted primarily as a dual-polarized dipole radiator, but this is merely exemplary and non-limiting.

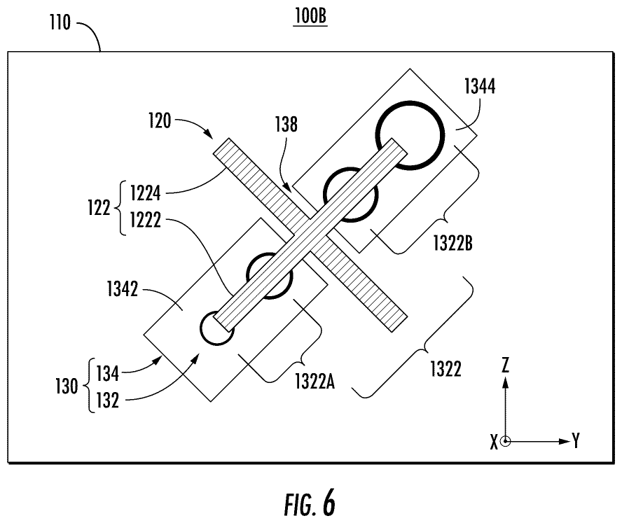

In some examples, the radiator 122 comprises a first dipole arranged along a first axis. The conductive cell array 132 may comprise first plurality of conductive cells arranged along the first axis. For example, FIG. 5 shows an example implementation 100A of the base station antenna 100, wherein the radiator 122 comprises a first dipole 1222 (also described herein as inclining at −45°) arranged along a first axis (e.g., in the YZ coordinate system, the equinoctial line of the first quadrant and the third quadrant), and the conductive cell array 132 comprises first plurality of conductive cells 1322 arranged along the first axis. In some examples, as shown in FIG. 5, a projected area of the first dipole 1222 on the reflector 110 falls into a projected area of the first plurality of conductive cells 1322 on the reflector 110, which facilitates narrowing the AZBW of its radiation beams when the first dipole 1222 is activated.

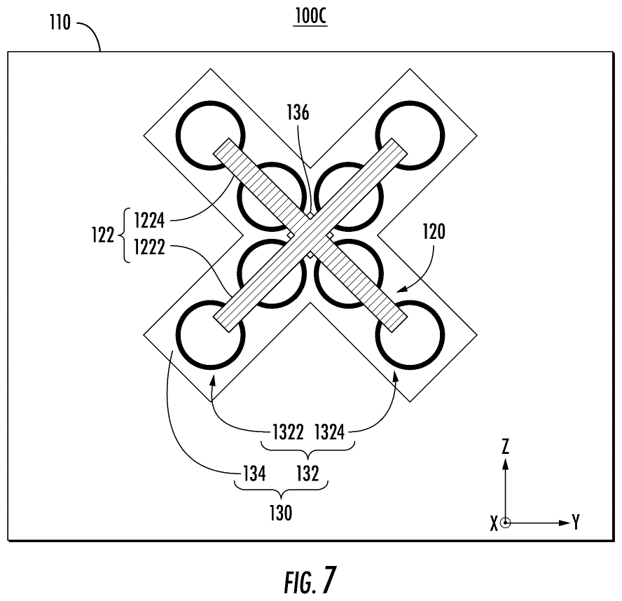

In some examples, the first plurality of conductive cells are identical in size to each other, for example, as shown in FIG. 5. In still further examples, the sizes of the first plurality of conductive cells gradually increase in a direction parallel to the first axis. For example, FIG. 6 shows an example implementation 100B of the base station antenna 100, wherein various conductive cells increase in sequence in a direction that rotates 45° clockwise relative to the Z direction. The smaller the sizes of the conductive cells, the earlier the phase of the beams. Thus, by gradually varying the sizes of the conductive cells in the conductive cell array 132, the PGM 130 may apply a phase gradient to the antenna beams in a position space. The phase difference of the beams incident to the PGM 130 at respective locations may be achieved utilizing the size difference of the conductive cells positioned at both ends of the PGM 130. In still further examples, various conductive cells may also change to increase in sequence in a direction that rotates 135° counter-clockwise relative to the Z direction. The maximum beam orientation of the antenna can be modulated by controlling the direction in which the sizes of the conductive cells increase. In other words, the direction in which the sizes of the conductive cells increase may be determined based on the desired antenna maximum beam orientation.

The first plurality of conductive cells 1322 may comprise any number of conductive cells. In some examples, the first plurality of conductive cells 1322 comprise at least one conductive cell positioned behind a first dipole arm of the first dipole 1222 and at least one conductive cell positioned behind a second dipole arm of the first dipole 1222. In the first plurality of conductive cells 1322, the number of conductive cells positioned behind the first dipole arm of the first dipole 1222 and the number of conductive cells positioned behind the second dipole arm of the first dipole 1222 may be the same or different, which may be determined depending on the particular installation (e.g., installation interference with other components in proximity).

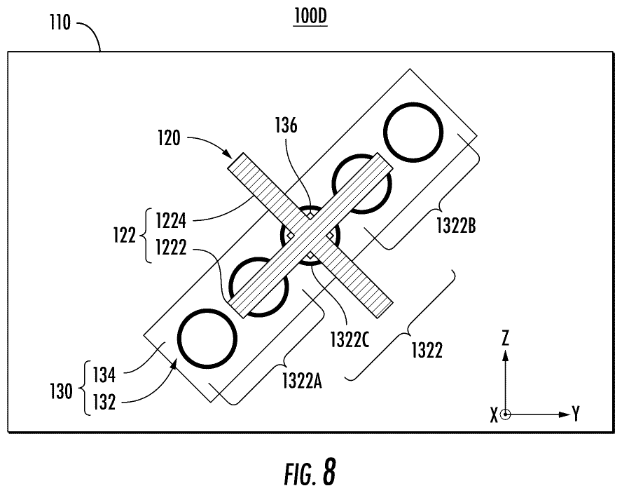

In some examples, the radiator 122 comprises a second dipole arranged along a second axis that is substantially perpendicular to the first axis. As used herein, “substantially perpendicular” means that the angle between the two is from 70° to 110°, preferably from 80° to 100°, more preferably from 85° to 95°, and is most preferably 90°. The conductive cell array 132 may comprise second plurality of conductive cells arranged along the second axis. For example, FIG. 7 shows an example implementation 100C of the base station antenna 100, wherein the radiator 122 comprises a first dipole 1222 arranged along a first axis (e.g., in the YZ coordinate system, the equinoctial line of the first quadrant and the third quadrant) and a second dipole 1224 arranged along a second axis (e.g., in the YZ coordinate system, the equinoctial line of the second quadrant and the fourth quadrant), and the conductive cell array 132 comprises first plurality of conductive cells 1322 arranged along the first axis and second plurality of conductive cells 1324 arranged along the second axis. In some examples, as shown in FIG. 7, a projected area of the second dipole 1224 on the reflector 110 falls into a projected area of the second plurality of conductive cells 1324 on the reflector 110, which facilitates narrowing the AZBW of its radiation beams when the second dipole 1224 is activated.

In some examples, the second plurality of conductive cells are identical in size to each other, for example, as shown in FIG. 7. In still further examples, the sizes of the second plurality of conductive cells gradually increase in a direction parallel to the second axis. As previously mentioned, the maximum beam orientation of the antenna can be modulated by controlling the direction in which the sizes of the conductive cells increase.

The second plurality of conductive cells 1324 may comprise any number of conductive cells and may comprise the same or different number of conductive cells as the first plurality of conductive cells 1322. In some examples, the second plurality of conductive cells 1324 comprise at least one conductive cell positioned behind a third dipole arm of the second dipole 1224 and at least one conductive cell positioned behind a fourth dipole arm of the second dipole 1224. In the second plurality of conductive cells 1324, the number of conductive cells positioned behind the third dipole arm of the second dipole 1224 and the number of conductive cells positioned behind the fourth dipole arm of the second dipole 1224 may be the same or different, which may be determined depending on the particular installation (e.g., installation interference with other components in proximity).

In some other examples, the conductive cell array 132 may also not comprise conductive cells arranged along the second axis, for example, as shown in FIG. 5 and FIG. 6.

The conductive cells in the conductive cell array 132 may be all arranged on the same dielectric substrate 134 or may be arranged on a plurality of dielectric substrates 134 in a scattered mode, which may be determined depending on the particular installation (e.g., installation interference with other components in proximity).

In some examples, for example, as shown in FIG. 5, the conductive cell array 132 comprises a first sub-array 1322A positioned on a first side of the feed stalk 124 (blocked in the figure) and a second sub-array 1322B positioned on a second side of the feed stalk 124 that is opposite to the first side. In the case of facilitating installation, the first sub-array 1322A and the second sub-array 1322B may be brought as close to each other to facilitate miniaturization of the base station antenna and avoid interference with other components.

In some examples, for example, as shown in FIG. 5 and FIG. 7, the dielectric substrate 134 comprises an opening 136 positioned between the first sub-array 1322A and the second sub-array 1322B, and the feed stalk 124 may extend through the opening 136.

In some examples, for example, as shown in FIG. 6, the dielectric substrate 134 comprises a first dielectric substrate 1342 and a second dielectric substrate 1344, the first sub-array 1322A is disposed on the first dielectric substrate 1342, the second sub-array 1322B is disposed on the second dielectric substrate 1344, and the feed stalk 124 extends through a gap 138 between the first dielectric substrate 1342 and the second dielectric substrate 1344.

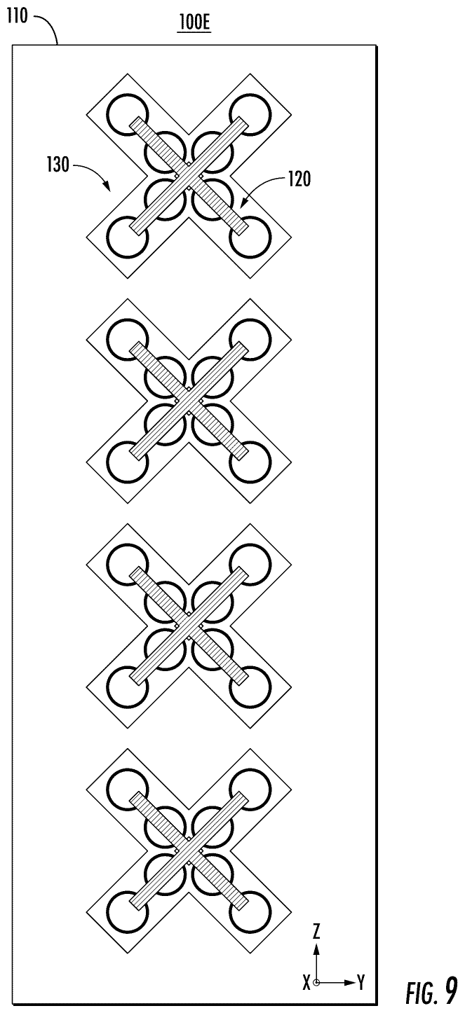

In some examples, the conductive cell array 132 may comprise a conductive cell positioned at the feed stalk 124. For example, FIG. 8 shows an example implementation 100D of a base station antenna 100, wherein the conductive cell array 132 comprises a conductive cell 1322C positioned at the feed stalk 124, the dielectric substrate 134 comprises an opening 136 positioned in the conductive cell 1322C, and the feed stalk 124 extends through the opening 136.

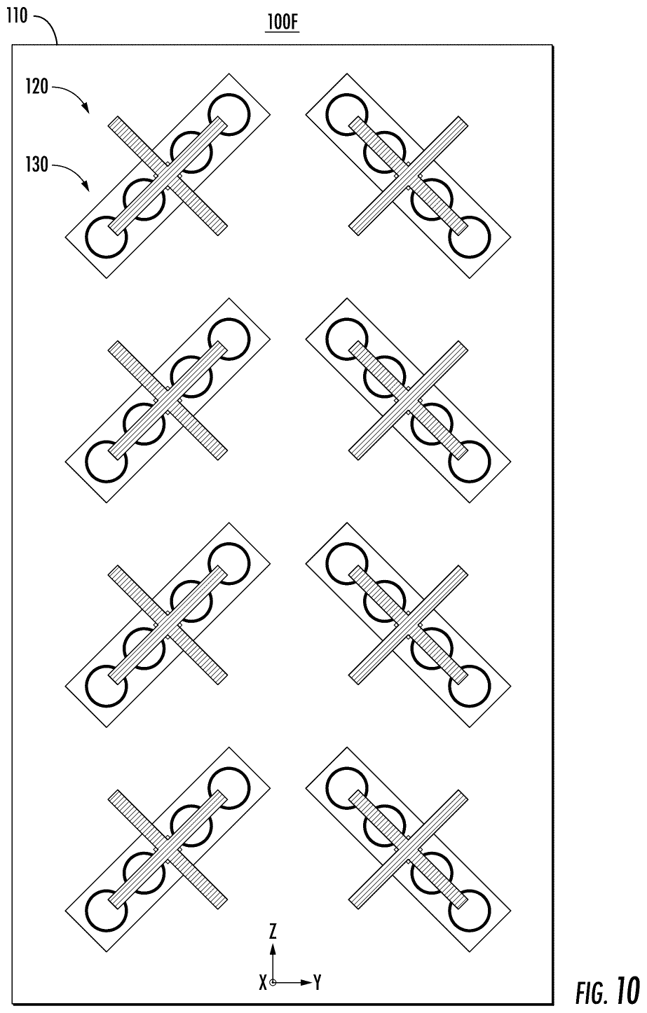

In some examples, the base station antenna 100 comprises a plurality of radiators 122 arranged in a single column, each radiator 122 comprises a first dipole arranged along a first axis and a second dipole arranged along a second axis that is substantially perpendicular to the first axis, a respective conductive cell array 132 is disposed between each radiator 122 and the reflector 110, and the conductive cell array 132 comprises first plurality of conductive cells arranged along the first axis and second plurality of conductive cells arranged along the second axis. For example, FIG. 9 shows an example implementation 100E of a base station antenna 100, wherein a plurality of radiating elements 120 are arranged in a single column, and a respective PGM 130 (more specifically, a conductive cell array) is disposed between the radiator of each radiating element 120 and the reflector 110. For such single-column configuration, it may be more advantageous to provide a plurality of conductive cells arranged along each of the two dipoles of the radiator of each radiating element 120 for each of the two dipoles of the radiator of each radiating element.

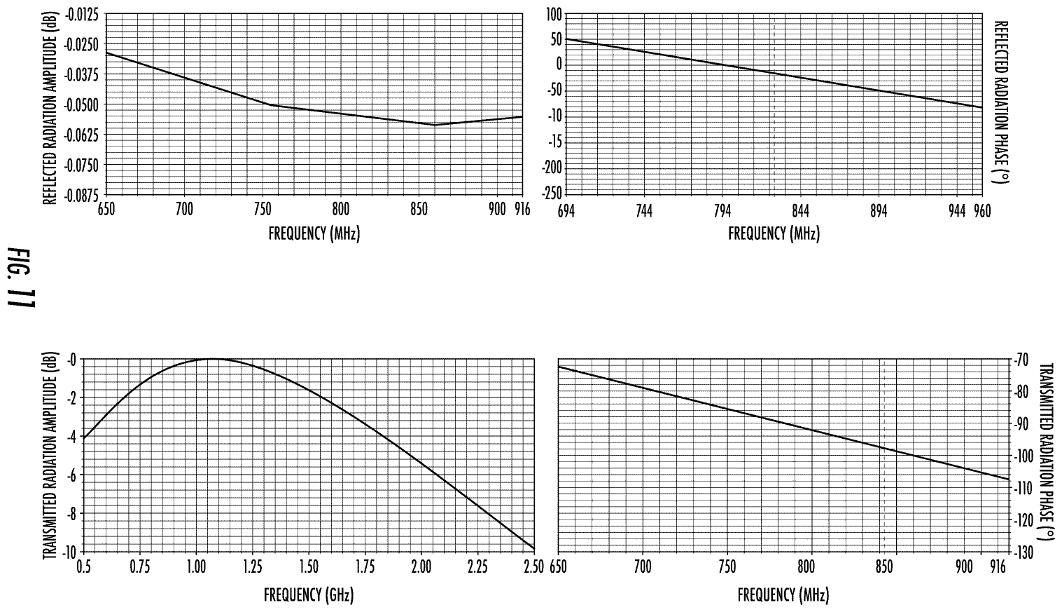

In some examples, the base station antenna 100 comprises a plurality of radiators 122 arranged in two columns, each radiator 122 comprises a first dipole arranged along a first axis and a second dipole arranged along a second axis that is substantially perpendicular to the first axis, a respective conductive cell array 132 is disposed between each radiator 122 and the reflector 110, and the conductive cell array 132 comprises first plurality of conductive cells arranged along the first axis and does not comprise conductive cells arranged along the second axis. For example, FIG. 10 shows an example implementation 100F of a base station antenna 100, wherein a plurality of radiating elements 120 are arranged in double columns, and a respective PGM 130 (more specifically, a conductive cell array) is disposed between the radiator of each radiating element 120 and the reflector 110. For such double-column configuration, it may be more advantageous to provide a plurality of conductive cells arranged along one of the two dipoles of the radiator of each radiating element 120 for one of the two dipoles of the radiator of each radiating element without providing a plurality of conductive cells arranged along the other dipole for the other dipole. Depending on the actual situation (e.g., installation interference, antenna maximum beam orientation, etc.), on which dipole the PGM 130 is disposed can be selected for each radiating element 120.

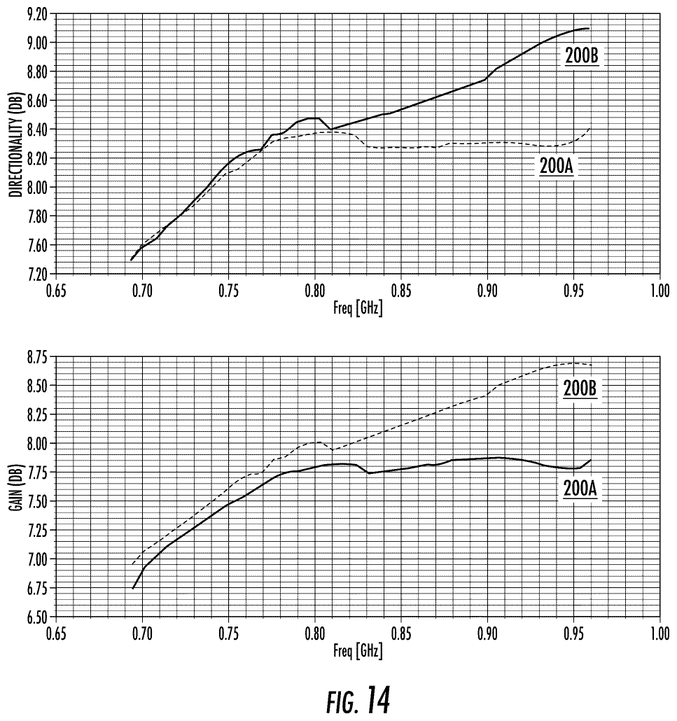

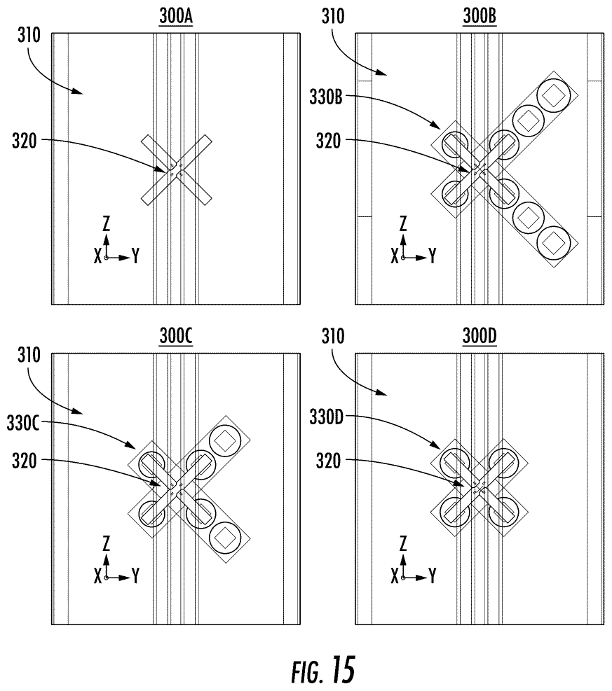

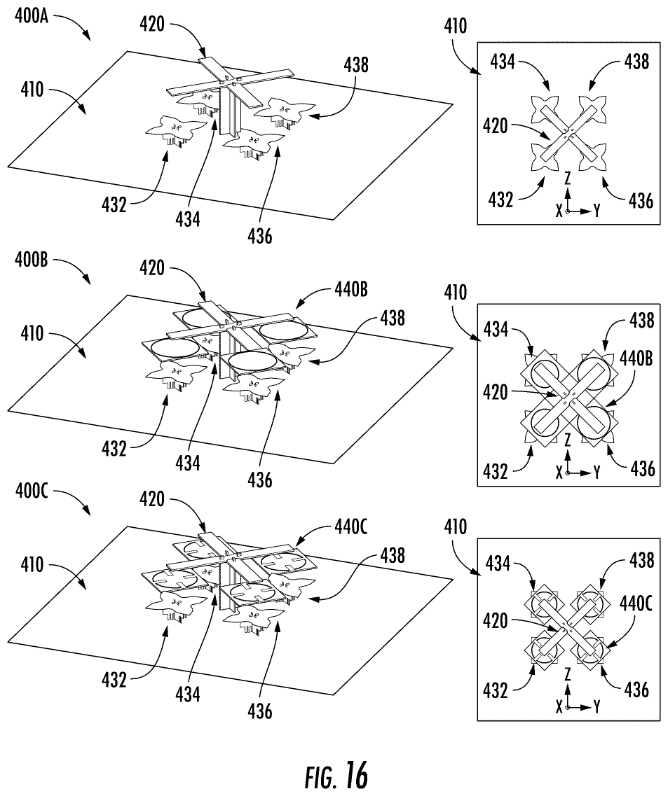

FIG. 12 schematically depicts a front view of a base station antenna 200A according to a first comparative example and a base station antenna 200B according to a second exemplary example of the present disclosure. The base station antenna 200A and the base station antenna 200B each comprise a double-column low-frequency band radiating element 220 installed on the reflector 210. Compared to the base station antenna 200A, the base station antenna 200B further comprises a PGM 230 disposed for one dipole of the low-frequency band radiating element 220. FIG. 13 shows radiation patterns of the base station antenna 200A and the base station antenna 200B. As can be seen from FIG. 14, the addition of the PGM 230 enhances the peak directionality and peak realization gains. Table 1 below shows comparisons of partial performance parameters of the base station antenna 200A and the base station antenna 200B. It can be seen that the addition of the PGM 230 not only reduces the AZBW, but also enhances the AZ directionality (i.e., the directionality of beams in an orientation plane).

TABLE 1

| Electrical specifications | 200A | 200B | 200A | 200B | 200A | 200B |
|---|---|---|---|---|---|---|
| Frequency range (MHz) | 694-790 | | 790-890 | | 890-960 | |
| 3 dB AZBW (°) | 71.2 | 70.2 | 70.5 | 65.1 | 76.8 | 60.8 |
| 10 dB AZBW (°) | 133.1 | 129.9 | 140.2 | 134.4 | 143.5 | 139 |
| AZ directionality (mean, dBi) | 6.71 | 6.78 | 6.65 | 6.91 | 6.43 | 6.96 |

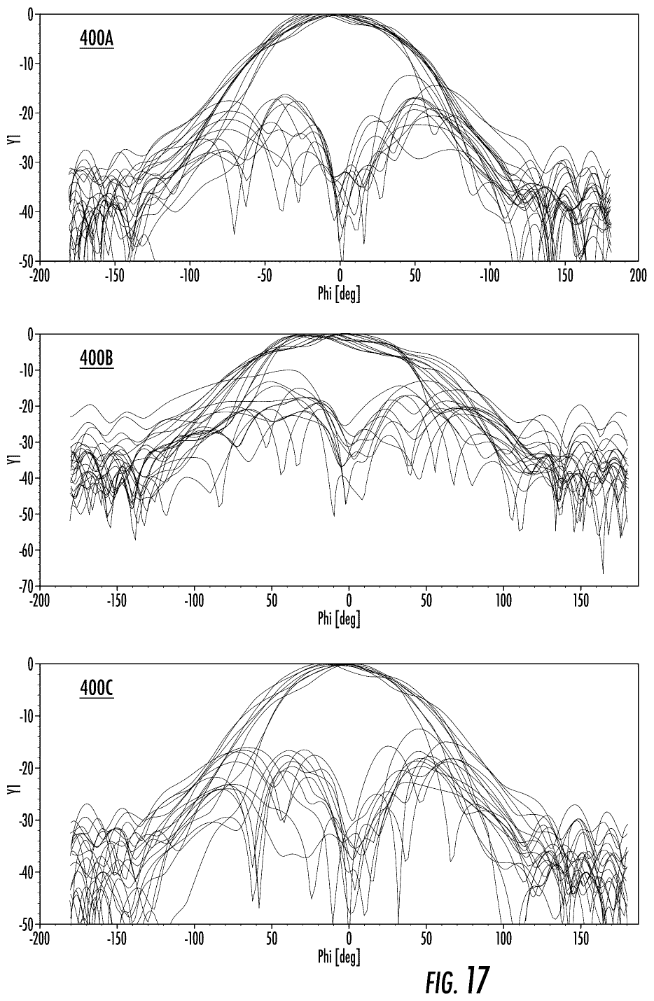

FIG. 15 schematically depicts front views of the base station antenna 300A according to the second comparative example and base station antennas 300B, 300C, 300D according to third to fifth exemplary examples of the present disclosure. The base station antennas 300A, 300B, 300C, 300D each comprise single-column low-frequency band radiating elements 320 installed on the reflector 310. Compared to the base station antenna 300A, the base station antennas 300B, 300C, 300D further comprise PGMs 330B, 330C, 330D disposed for two dipoles of the low-frequency band radiating element 320. The numbers of conductive cells included in the PGMs 330B, 330C, 330D decrease in sequence. Table 2 below shows comparisons of partial performance parameters of the base station antennas 300A, 300B, 300C, 300D. It can be seen that the addition of the PGM 330 not only reduces the AZBW and ELBW (elevation beam width), but also enhances the peak directionality and realization gains. In addition, the AZBW can still be narrowed even if the number of the conductive cells decreases

TABLE 2

| Electrical specifications | 300A | 300B | 300C | 300D |
|---|---|---|---|---|
| 3 dB AZBW (°) | 72 | 67.3 | 66.7 | 70 |
| 10 dB AZBW (°) | 129.8 | 128.2 | 125.2 | 128.5 |
| 3 dB ELBW (°) | 75.8 | 62.6 | 71.1 | 73.9 |
| 10 dB ELBW (°) | 131.9 | 125.3 | 128.6 | 130.6 |
| Peak directionality (dB) | 8.58 | 9.0 | 8.9 | 8.69 |
| Realization gain (dB) | 8.18 | 8.8 | 8.64 | 8.39 |
| Radiation efficiency (%) | 98 | 98 | 98 | 98 |
| Total efficiency (%) | 91 | 95 | 94 | 93 |

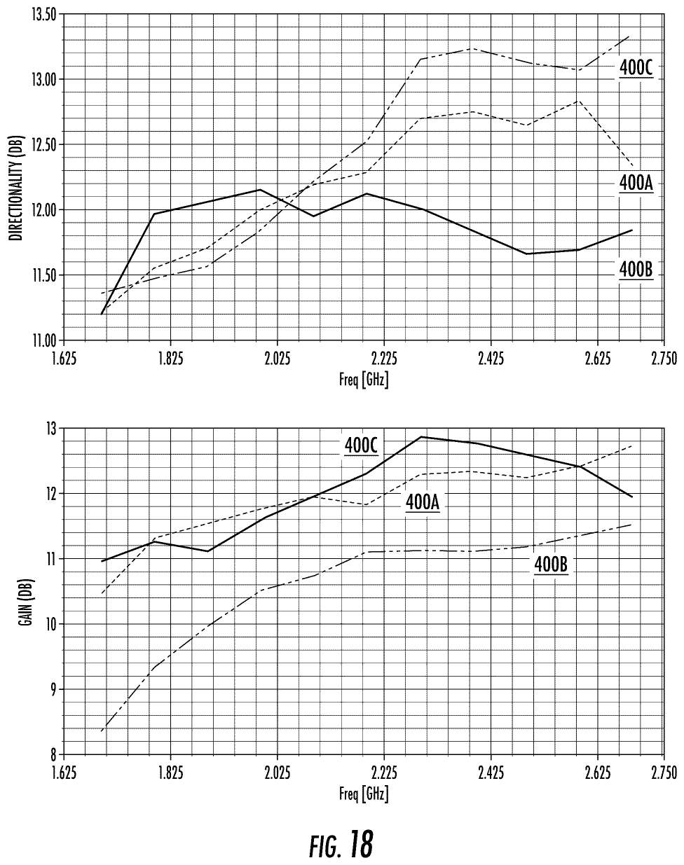

FIG. 16 schematically depicts perspective views and front views of a base station antenna 400A according to the third comparative example and base station antennas 400B, 400C according to sixth to seventh exemplary examples of the present disclosure. The base station antennas 400A, 400B, 400C each comprise single-column low-frequency band radiating elements 420 and double-column mid-frequency band radiating elements 432, 434, 436, 438 installed on the reflector 410. Compared to the base station antenna 400A, the base station antennas 400B, 400C further comprise PGMs 440B, 440C disposed for two dipoles of the low-frequency band radiating element 420. The conductive cells of the PGM 440B adopt the design of (A) in FIG. 2, and the conductive cells of the PGM 440C adopt the design in FIG. 4.

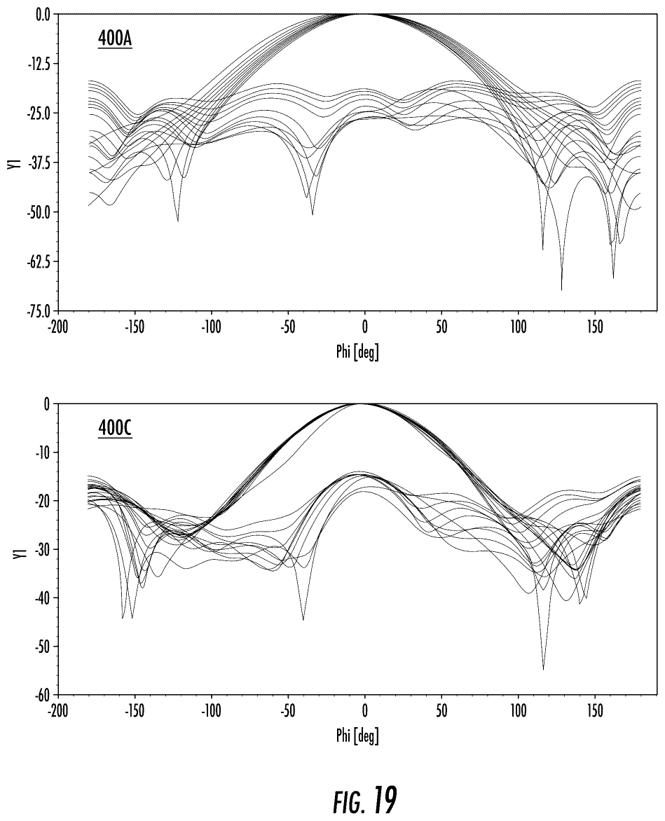

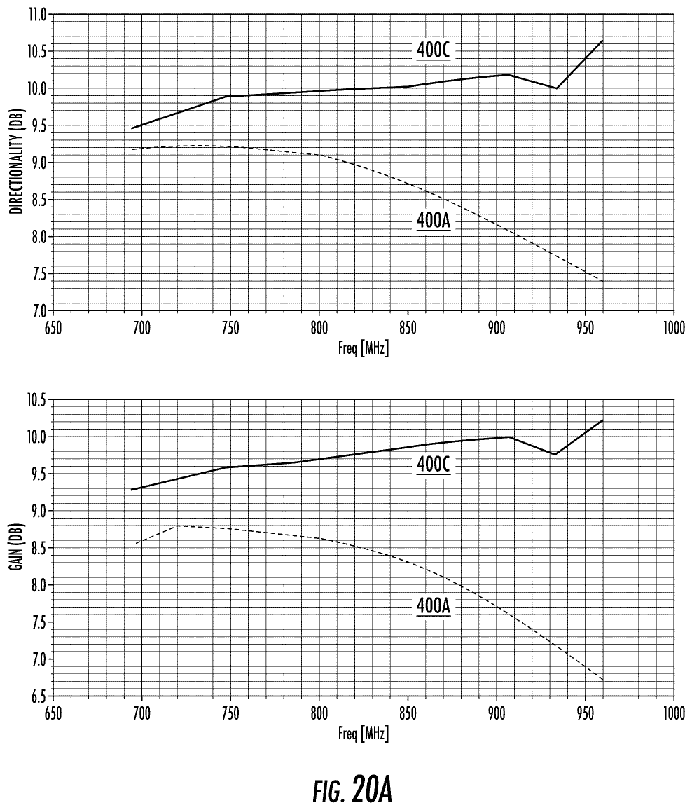

FIG. 17 shows radiation patterns of the base station antennas 400A, 400B, 400C when the dipoles of the two adjacent mid-frequency band radiating elements 432, 434 that incline at +45° are activated. FIG. 18 shows the 3D directionality and realization gains. It can be seen that compared to the PGM 440B, the PGM 440C achieves the better 3D directionality and realization gains as a result of being “invisible” to the mid-frequency band radiating element. Table 3 below shows comparisons of partial performance parameters of the base station antennas 400A and 400C. It can be seen that the addition of the PGM 440C can also narrow the AZBW of the mid-frequency band radiation.

TABLE 3

| Electrical | | | | | | | | |
|---|---|---|---|---|---|---|---|---|
| specifications | 400A | 400C | 400A | 400C | 400A | 400C | 400A | 400C |
| Frequency range | 1685-1995 | | 1920-2300 | | 2300-2500 | | 2490-2690 | |
| (MHz) | | | | | | | | |
| 3 dB AZBW (°) | 70 | 68.6 | 58.2 | 59.5 | 58.2 | 55 | 63 | 58.6 |
| 10 dB AZBW (°) | 118.9 | 123.1 | 120.2 | 115.5 | 117.6 | 111.3 | 104.9 | 100.5 |
| 3D directionality | 11.63 | 11.59 | 12.31 | 12.38 | 12.71 | 13.11 | 12.63 | 13.22 |
| (mean, dBi) | | | | | | | | |
| AZ directionality | 7.08 | 7.04 | 7.44 | 7.48 | 7.52 | 7.72 | 7.54 | 7.78 |
| (mean, dBi) | | | | | | | | |
| EL directionality | 4.81 | 4.8 | 5.33 | 5.42 | 5.76 | 5.89 | 5.94 | 6.05 |
| (mean, dBi) | | | | | | | | |

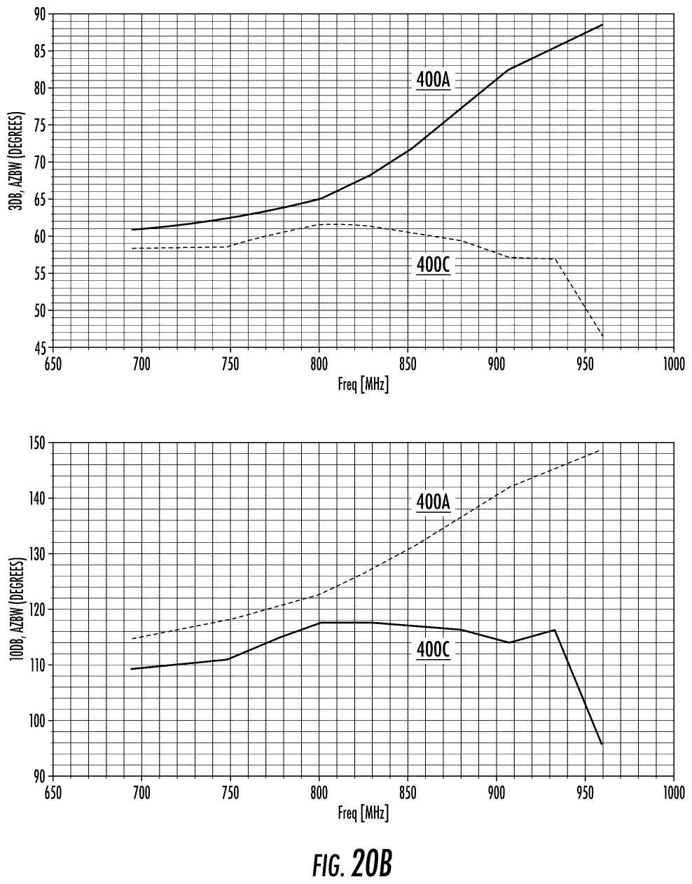

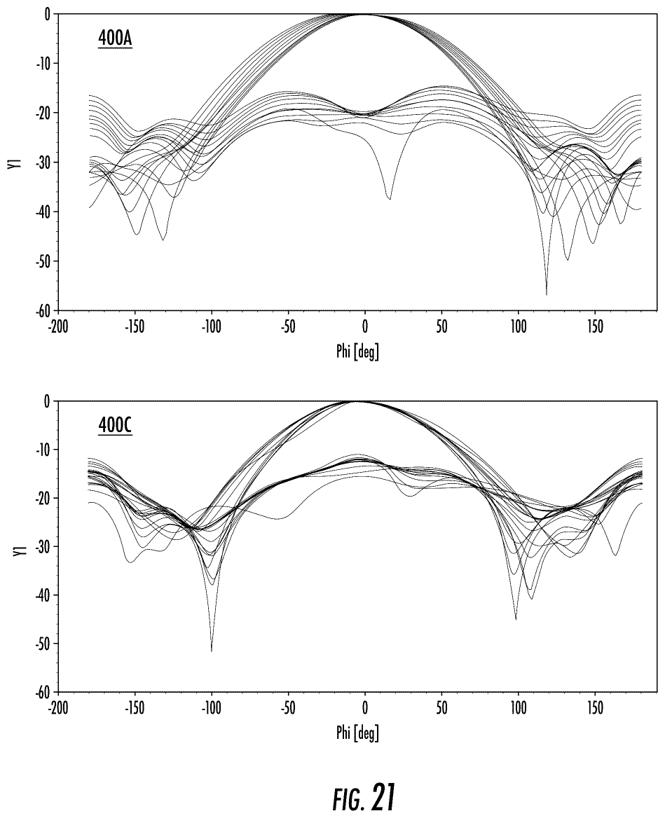

FIG. 19 shows radiation patterns of base station antennas 400A, 400C when dipoles of the low-frequency band radiating element 420 that incline at +45° are activated. In connection with FIGS. 20A and 20B, it can be seen that the addition of the PGM 440C enhances the 3D directionality and realization gains of the low-frequency band radiation and reduces the 3 dB AZBW and the 10 dB AZBW.

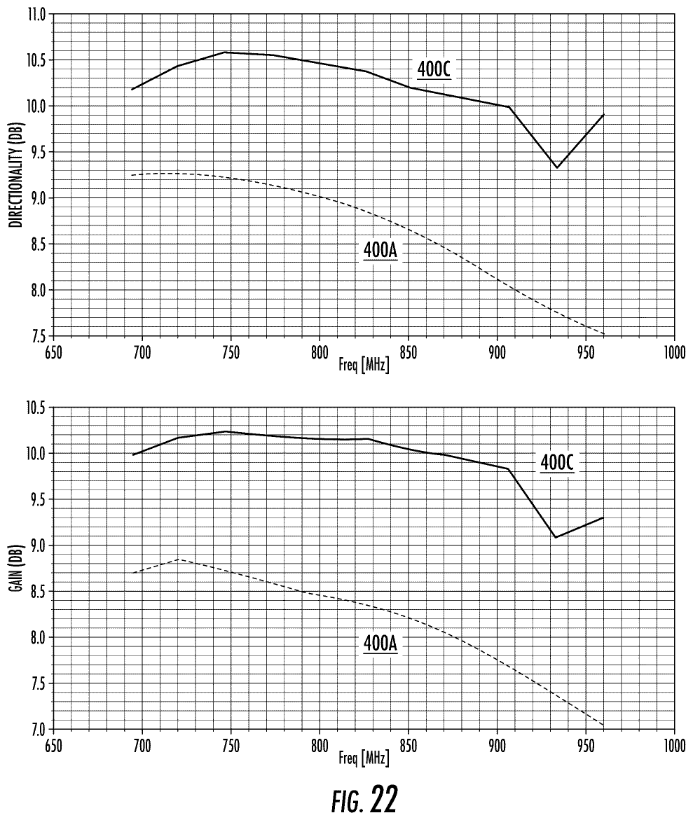

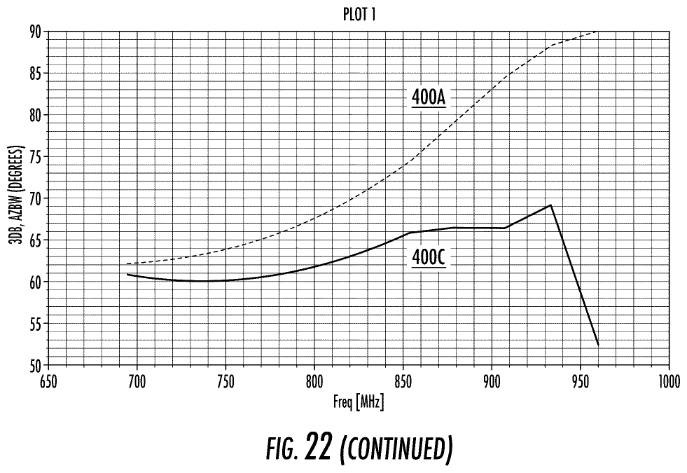

FIG. 21 shows radiation patterns of base station antennas 400A, 400C when dipoles of the low-frequency band radiating element 420 that incline at −45° are activated. In connection with FIG. 22, it can be seen that the addition of the PGM 440C enhances the 3D directionality and realization gains of the low-frequency band radiation and reduces the 3 dB AZBW.

The terms “left”, “right”, “front”, “rear”, “top”, “bottom”, “upper”, “lower”, “high”, “low” in the Specification and Claims, if present, are used for descriptive purposes and not necessarily used to describe constant relative positions. It should be understood that the terms used in this way are interchangeable under appropriate circumstances, so that the examples of the present disclosure described herein, for example, can operate on other orientations that differ from those orientations shown herein or otherwise described. For example, when the device in the attached drawing is turned upside down, features that were originally described as “above” other features can now be described as “below” other features. The device may also be oriented by other means (rotated by 90 degrees or at other locations), and at this time, a relative spatial relation will be explained accordingly.

In the Specification and the Claims, when an element is referred to as being “above” another element, “attached” to another element, “connected” to another element, “coupled” to another element, or “in contact with” another element, the element may be directly above another element, directly attached to another element, directly connected to another element, directly coupled to another element, or directly in contact with another element, or there may be one or a plurality of intermediate elements. In contrast, if an element is described as “directly” “above” another element, “directly attached” to another element, “directly connected” to another element, “directly coupled” to another element or “directly in contact with” another element, there will be no intermediate elements. In the Specification and Claims, a feature that is arranged “adjacent” to another feature, may denote that a feature has a part that overlaps an adjacent feature or a part positioned above or below the adjacent feature.

As used herein, the word “exemplary” means “serving as an example, instance, or illustration” rather than as a “model” to be copied exactly. Any realization method described exemplarily herein is not necessarily interpreted as being preferable or advantageous over other realization methods. Moreover, the present disclosure is not limited by any expressed or implied theory given in the technical field, background art, summary of the invention, or specific implementation methods.

As used herein, the word “substantially” means comprising any minor changes caused by design or manufacturing defects, device or component tolerances, environmental influences, and/or other factors. The word “substantially” also allows the gap from the perfect or ideal situation due to parasitic effects, noise, and other practical considerations that may be present in the actual realization.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

It should also be understood that when the term “include/comprise” is used in this text, it indicates the presence of the specified feature, entirety, step, operation, cell and/or component, but does not exclude the presence or addition of one or more other features, entireties, steps, operations, cells and/or components and/or combinations thereof. In the present disclosure, the term “provide” is used in a broad sense to cover all ways of obtaining an object, so “providing an object” comprises but is not limited to “purchase”, “preparation/manufacturing”, “arrangement/setting”, “installation/assembly”, and/or “order” of the object, etc.

As used herein, the term “and/or” comprises any and all combinations of one or more of the associated listed items. The terms used herein are only for the purpose of describing specific examples and are not intended to limit the present disclosure. As used herein, the singular forms “a”, “an” and “the” are also intended to include the plural forms, unless the context clearly dictates otherwise.

The same or similar portions among various examples of the present disclosure are recited to each other, with each example focusing on differences from other examples. Throughout the description of the present disclosure, reference to the terms “one example,” “some examples,” “examples,” “specific examples,” or “some examples,” “exemplary” and other descriptions means that specific features, structures, materials, or characteristics described in connection with the example or example are included in at least one example or example of the present disclosure. In the present disclosure, the illustrative expression of the above terms must not be directed to the same examples or examples. Moreover, the specific features, structures, materials, or characteristics described may be combined in a suitable manner in any one or more examples or examples. Moreover, without contradiction, those skilled in the art may incorporate and combine different examples or examples described in the present disclosure, as well as the features of the different examples or examples.

In addition, when used in the present disclosure, the words “here,” “above,” “below,” “herein,” “below,” “above,” and similar meanings shall refer to the present disclosure as a whole and not to any particular part of the present disclosure. Further, unless expressly stated otherwise or otherwise understood in the context used, conditional language used herein, such as “can,” “may,” “e.g.,” “such as,” and the like, is generally intended to express that certain examples comprise certain features, elements, and/or states while other examples do not comprise them. Accordingly, such conditional language is not generally intended to imply that one or more examples require features, elements, and/or states in any way, or whether these features, elements, and/or states are included or certain features, elements, and/or states are performed in any particular example.

Those skilled in the art should realize that the boundaries between the above operations are merely illustrative. A plurality of operations can be combined into a single operation, which may be distributed in the additional operation, and the operations can be executed at least partially overlapping in time. Also, alternative examples may include a plurality of instances of specific operations, and the order of operations may be changed in other various examples. However, other modifications, changes and substitutions are also possible. Aspects and elements of all examples disclosed above may be combined in any manner and/or in conjunction with aspects or elements of other examples to provide a plurality of additional examples.

1. A base station antenna, comprising:
a reflector;
a first radiator positioned in front of the reflector and configured to operate within a first operating frequency range; and
a dielectric substrate positioned between the first radiator and the reflector and having a conductive cell array disposed thereon,
wherein the dielectric substrate having the conductive cell array constitutes a phase gradient meta-surface (PGM), and the PGM is configured to apply a phase gradient to radiation incident on the PGM within the first operating frequency range.

2. (canceled)

3. The base station antenna of claim 1, wherein the PGM is configured to reflect a first part of the rearwardly emitted radiation of the first radiator, the reflector is configured to reflect a second part of the rearwardly emitted radiation of the first radiator, and the second part transmits through the PGM.

4. The base station antenna of claim 1, comprising:
a second radiator positioned in front of the reflector and closer to the reflector than the conductive cell array, wherein the second radiator is configured to operate within a second operating frequency range, and the second operating frequency range is higher than the first operating frequency range,
wherein the PGM is configured to allow radiation within the second operating frequency range to pass through the PGM.

5. The base station antenna of claim 1, wherein each conductive cell in the conductive cell array comprises a conductive trace having a substantially circular outer profile.

6. (canceled)

7. The base station antenna of claim 5, wherein each conductive cell comprises a substantially square conductive patch disposed within a perimeter defined by a conductive trace segment.

8. (canceled)

9. The base station antenna of claim 5, wherein a choke is disposed in the conductive trace.

10. The base station antenna of claim 9, comprising:
a second radiator positioned between the conductive cell array and the reflector and configured to operate within a second operating frequency range, and the second operating frequency range is higher than the first operating frequency range,
wherein a length of the choke is approximately a quarter of a wavelength at a central operating frequency of the second operating frequency range.

11. The base station antenna of claim 1, wherein the first radiator comprises a first dipole arranged along a first axis,
wherein the conductive cell array comprises first plurality of conductive cells arranged along the first axis.

12-14. (canceled)

15. The base station antenna of claim 11, wherein the first radiator comprises a second dipole arranged along a second axis that is substantially perpendicular to the first axis,
wherein the conductive cell array does not include conductive cells arranged along the second axis.

16-21. (canceled)

22. The base station antenna of claim 1, wherein the first radiator is approximately a quarter of a wavelength at a central operating frequency of the first operating frequency range from the reflector, and the conductive cell array is approximately one eighth of the wavelength at the central operating frequency of the first operating frequency range from the reflector.

23. A base station antenna, comprising:
a reflector;
a radiator positioned in front of the reflector; and
a dielectric substrate positioned between the radiator and the reflector and having a conductive cell array disposed thereon,
wherein each conductive cell in the conductive cell array comprises a conductive trace having a substantially circular outer profile.

24. The base station antenna of claim 23, wherein an inner radius of the conductive trace is approximately one tenth of a wavelength at a central operating frequency of an operating frequency range of the radiator.

25. The base station antenna of claim 23, wherein each conductive cell comprises a substantially square conductive patch disposed within a perimeter defined by a conductive trace segment.

26-28. (canceled)

29. The base station antenna of claim 23, wherein the radiator comprises a first dipole arranged along a first axis,
wherein the conductive cell array comprises first plurality of conductive cells arranged along the first axis.

30. The base station antenna of claim 29, wherein sizes of the first plurality of conductive cells gradually increase in a direction parallel to the first axis.

31. The base station antenna of claim 29, wherein the first plurality of conductive cells are identical in size to each other.

32-34. (canceled)

35. The base station antenna of claim 23, wherein the base station antenna comprises a plurality of radiators arranged in two columns, each of the plurality of radiators comprises a first dipole arranged along a first axis and a second dipole arranged along a second axis that is substantially perpendicular to the first axis, a respective conductive cell array is disposed between each of the plurality of radiators and the reflector, and the conductive cell array comprises first plurality of conductive cells arranged along the first axis and does not comprise conductive cells arranged along the second axis.

36. The base station antenna of claim 23, wherein the radiator is positioned on a forward end of a feed stalk that extends forwardly from the reflector, the conductive cell array comprises a first sub-array positioned on a first side of the feed stalk and a second sub-array positioned on a second side of the feed stalk that is opposite to the first side.

37. The base station antenna of claim 36, wherein the dielectric substrate comprises a first dielectric substrate and a second dielectric substrate, the first sub-array is disposed on the first dielectric substrate, the second sub-array is disposed on the second dielectric substrate, and the feed stalk extends through a gap between the first dielectric substrate and the second dielectric substrate.

38. The base station antenna of claim 36, wherein the dielectric substrate comprises an opening positioned between the first sub-array and the second sub-array, and the feed stalk extends through the opening.

39-40. (canceled)
